(19) United States
(12) Patent Application Publication
(10) Pub. No.: US 2013/0263501 A1
(43) Pub. Date: Oct. 10, 2013

(54) SYSTEM AND METHOD FOR BIOMASS FUEL PRODUCTION AND INTEGRATED BIOMASS AND BIOFUEL PRODUCTION

(71) Applicants: James Russell Monroe, Fairview, TX (US); David Thomas Schroeder, Watertown, WI (US); Charles Hawk Cotter, Plano, TX (US)

(72) Inventors: James Russell Monroe, Fairview, TX (US); David Thomas Schroeder, Watertown, WI (US); Charles Hawk Cotter, Plano, TX (US)

(21) Appl. No.: 13/441,288

(22) Filed: Apr. 6, 2012

(51) Int. Cl. A01G 1/00; C10B 57/00

(52) U.S. Cl. 47/1.4; 202/96

(57) ABSTRACT

In one embodiment, a system may include a leaching system configured to receive biomass and rinse the biomass in an acidic solution such that water soluable combustion unfriendly chemical components in the biomass are leached into an effluent. The system may further include a torrefaction reactor configured to receive the biomass and heat the biomass to generate torrefied biomass.

### TECHNICAL FIELD

The present disclosure relates generally to biomass fuel production and integrated biomass and biofuel production.

### BACKGROUND

In general, the term “biomass” can be used to include all organic matter (e.g., all matter that originates from photosynthesis). Biomass can include wood, plants, vegetable oils, green waste, manure, sewer sludge, or any other form or type of organic matter.

Biomass may be transformed by heat in a low oxygen environment, by a process known as torrefaction, into a hydrophobic, decay-resistant material that may be used as a fuel (e.g., as a coal fuel substitute, a feedstock for entrained-flow gasification, or other fuel), a soil additive, a long-term carbon storage mechanism, or for other suitable use. In particular, torrefied biomass may be used in existing fuel-burning power plants (e.g., coal-burning power plants), thus facilitating the use of renewable fuels with existing fuel-burning infrastructure to generate electricity. In addition, use of torrefied biomass as a fuel may provide a carbon-neutral means of providing energy.

Torrefaction of biomass may be described as a mild form of pyrolysis at temperatures typically ranging between 230°-320° C. During torrefaction, water present in the biomass may evaporate and biopolymers (e.g., cellulose, hemicellulose, and lignin) of the biomass may partially decompose, giving off various types of volatile organic compounds (referred to as “torgas”), resulting in a loss of mass (e.g., between approximately 30% and approximately 40%) and chemical energy (e.g., between approximately 10% and approximately 20%) in the gas phase. However, because more mass than energy is lost, torrefaction results in energy densification, yielding a solid product with lower moisture content and higher energy content compared to untreated biomass. The resulting product may be solid, dry, dark brown or blackened material which is referred to as “torrefied wood”, “torrefied biomass,” “biocoal,” or “renewable coal replacement fuel” (“RCRF”).

RCRF may have more energy density than non-torrefied biomass, resulting in reduced transportation and handling costs, and other economic advantage. To further improve transportation efficiencies, torrefied biomass may be “densified” by pelletization and/or briquetting. Due to the increased ease of handling and energy densification of densified, torrefied biomass, and the fact that some sources of biomass may be sustainable or reclaimed materials, RCRF has increasingly received attention as a “green,” carbon-neutral, environmentally-friendly energy solution.

Many other characteristics of RCRF enable it to be a viable green energy solution. For example, biomass can be produced from a wide variety of raw biomass feedstocks while yielding similar product properties. In addition, torrefied biomass has hydrophobic properties, and when combined with densification make bulk storage in open air feasible. Further, torrefaction leads to the elimination of biological activity, reducing the risk of spontaneous combustion and ceasing biological decomposition. Moreover, torrefaction of biomass allows for improved grindability of biomass, leading to more efficient co-firing in existing fuel-burning power plants or entrained-flow gasification for the production of chemicals and transportation fuels.

However, despite such advantages, many existing processes and systems for RCRF production have numerous disadvantages. For example, coal-burning power plants are typically engineered toward the consumption of specific coal types having specific physical and chemical properties. Thus, the use of non-improved, biomass-derived RCRF as a fuel within existing coal-burning power plants may introduce technical risk to boilers as biomass contains significantly different chemical properties than coal, which may impact the combustion reaction, performance, and maintenance of the fuel-burning boilers. In particular, RCRF, compared to traditional coal products, if not improved prior to the RCRF production process, includes higher amounts of combustion unfriendly chemical components. As used herein “combustion unfriendly chemical components” may lead to elevated slagging, fouling, and corrosion of boiler equipment, emissions control equipment, and/or other plant equipment, as well as leading to undesirable emissions of such combustion unfriendly chemical components, and may include without limitation volatile matter, chlorine, potassium, sodium, magnesium, phosphorus, calcium, silica, and other chemical components.

Short rotation crops (e.g., less than or equal to approximately 10-year regrowth) used as a biomass source for RCRF such as mesquite, willow, eucalyptus, swtichgrass, and miscanthus exhibit unacceptably high levels of combustion unfriendly chemical components. Methods exist to mitigate such slagging, fouling, and corrosion caused by unrefined biomass and/or RCRF at the point of combustion within the coal-burning power plant, but such methods typically require modification to physical fuel-burning power plants which are capital intensive and increase operating costs.

In addition, processes for production of RCRF require combustion heat for both drying and torrefaction, which produces emissions (hazardous and non-hazardous) which leads to increased permitting and environmental compliance costs for the producer of RCRF.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a flow diagram of an example method for harvesting and preparing biomass for torrefaction, in accordance with certain embodiments of the present disclosure; and

FIG. 2 illustrates a block diagram of selected components of an example integrated biomass and biofuel production system, in accordance with certain embodiments of the present disclosure.

### SUMMARY

In accordance with embodiments of the present disclosure, a system may include a leaching system and a torrefaction reactor. The leaching system may be configured to receive biomass and leach the biomass such that water soluable combustion unfriendly chemical components present in the biomass are leached into an effluent. The torrefaction reactor may be configured to receive the leached biomass and heat the biomass to generate torrefied biomass. The algaculture production system may be configured to receive at least a portion of the effluent from the leaching system and cultivate algae in a liquid comprising the portion of the effluent received from the leaching system.

### DETAILED DESCRIPTION

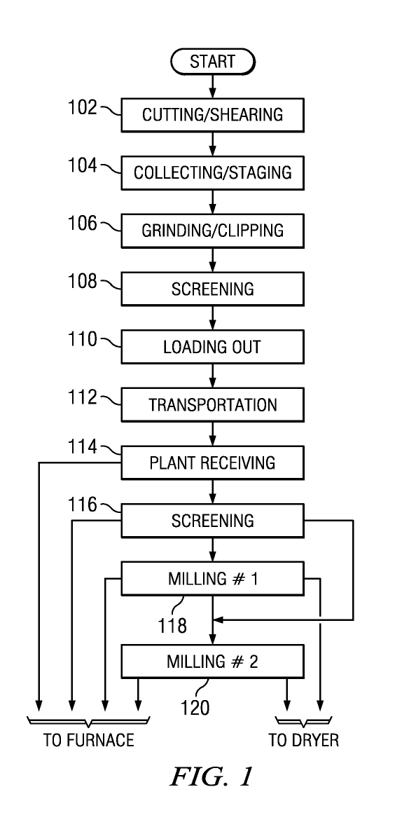

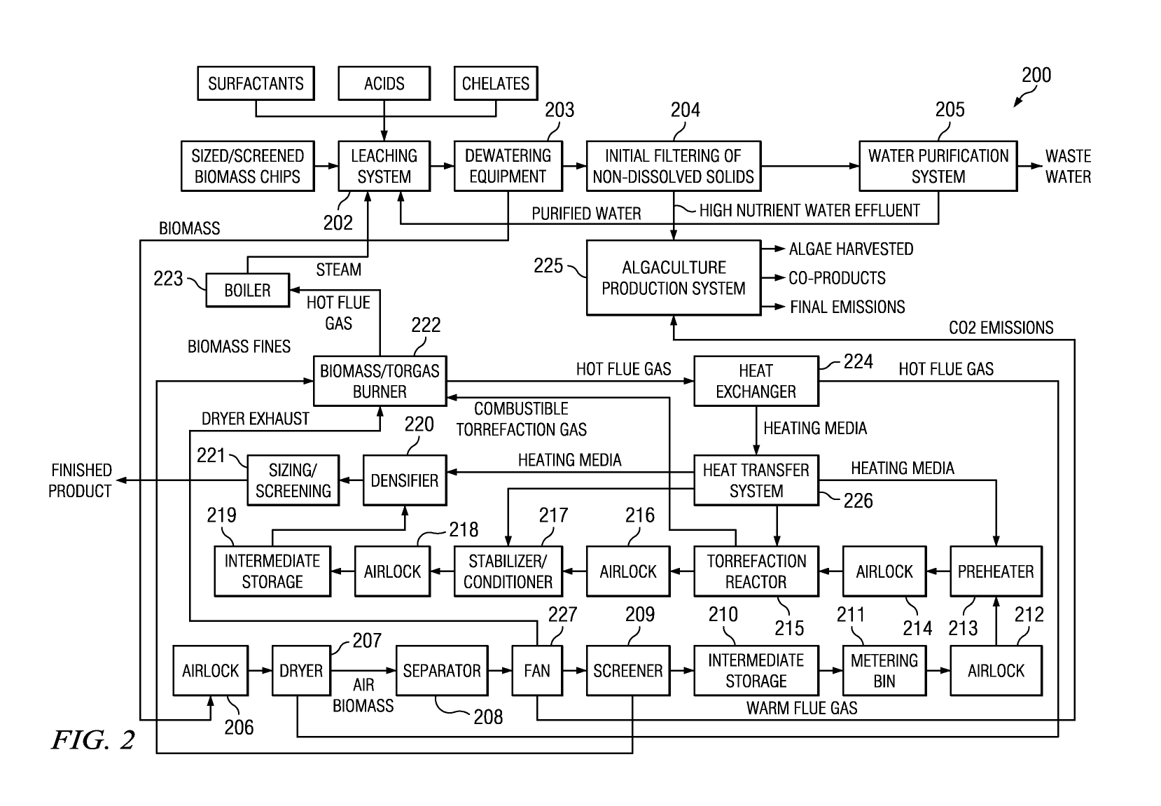

Preferred embodiments and their advantages are best understood by reference to FIGS. 1 and 2, wherein like numbers are used to indicate like and corresponding parts.

FIG. 1 illustrates a flow diagram of an example method 100 for harvesting and processing biomass for torrefaction, in accordance with certain embodiments of the present disclosure. According to certain embodiments, method 100 may begin at block 102. Teachings of the present disclosure may be implemented in a variety of configurations. Although FIG. 1 discloses a particular number of steps to be taken with respect to method 100, method 100 may be executed with greater or lesser steps than those depicted in FIG. 1. In addition, although FIG. 1 discloses a certain order of steps to be taken with respect to method 100, the steps comprising method 100 may be completed in any suitable order.

Method 100 may start with field harvesting of biomass. In certain embodiments, harvesting may begin with cutting or shearing 102 of trees or other plants. As used in the context of harvesting woody and plant-based biomass, cutting or shearing may refer to harvesting a plant such that the root system of the plant remains embedded in soil. Cutting or shearing may allow for sustainable harvesting of species of plants that may re-propagate or re-grow after being cut or sheared. For example, many species of trees including mesquite, fast-growing hardwoods, and bamboo, may grow shunts from the roots, remaining trunk of a cut or sheared tree or other plant, thus providing for later re-harvesting from the same plant or tree at a later time. As a specific example, biomass may be efficiently harvested from a single mesquite tree approximately once every 10 years.

Harvesting may continue with collecting and staging 104 of the cut or sheared biomass. Collecting and staging may include collecting, with appropriate equipment, the cut or sheared biomass and staging (e.g., stacking, transporting) for grinding or chipping. Grinding or chipping 106 may include using a commercially-available wood hog, wood grinder, wood chipper, or other similar apparatus that may receive collected biomass as an input and produce as output chips (e.g., wood chips) of a desired size (e.g., a maximum length of approximately ten to fifteen centimeters in any dimension. Grinding or chipping of biomass in the field may increase the volume of biomass that may be transported from a harvest site by a truck, trailer, or other vehicle.

In some embodiments, after grinding or chipping of biomass, biomass chips may be subject to screening in the field 108. Screening may be performed by one or more screening systems and/or other similar devices capable of segregating chips by size, weight, shape and/or other physical characteristics. Screening, if utilized, may segregate biomass chips unsuitable for conversion into RCRF and remove undesirable material (e.g., dirt, sand, etc.) or foreign objects (e.g., rocks, tramp metal, etc.).

After grinding or chipping 106 (and after field screening 108, in embodiments in which screening in the field is applied), biomass chips may be loaded 110 into trucks, trailers, and/or other vehicles for transportation 112 to a plant for further processing, including torrefaction. At the completion of transportation 112 from the field, biomass may be received 114 at a plant. As used herein, “plant” is used generally to refer to any plant, chipyard, and/or any other suitable facility for processing biomass to produce RCRF. Upon receipt at a plant, biomass may be stored in bins, containers, in piles, and/or in any other suitable manner.

Following receipt at the plant, screening 116 may be applied to the biomass. Screening may be performed manually based on observed characteristics of biomass chips, or may be performed by one or more screening systems, masks, and/or other similar devices capable of segregating chips by size, weight, shape, and/or other characteristics. Screening, if utilized, may segregate biomass chips into those deemed unsuitable for torrefaction and conversion into RCRF (“rejects”), those requiring milling to a smaller size suitable for torrefaction and conversion into RCRF (e.g., “oversized” chips that are greater than is deemed appropriate), and those suitable for torrefaction (“accepts”).

Biomass chips determined to be oversized by plant screening 116 may be conveyed or otherwise transported to a hammermill or other suitable apparatus for milling 118 and/or 120.

Oversized chips may be reduced in size by milling 118 and/or milling 120. For example, screening 116 may further segregate oversized chips into two groups, one of which may include oversized chips larger than chips of the other group. The group of larger chips may be fed for milling 118 while the smaller group of chips may be fed for milling 120. Chips milled in milling 118 may be further screened (not shown) to determine those that are “accepts” after milling 118 and those requiring further milling 120. Although not depicted, additional screening may be performed after milling 118 and/or 120 to again segregate chips into accepts, rejects, and/or oversized. If chips remained oversized after milling 118 and/or 120, such chips may be again fed for milling 118 and/or 120.

After the harvesting and processing of method 100 is complete, biomass “accepts” may be conveyed to airlock 202 of system 200, where such accepts may be used as a feedstock for torrefaction, and “rejects” from screening 116, milling 118, and/or milling 120 may be conveyed to furnace 222 of system 200, where such rejects may be used as solid, untorrefied fuel for furnace 222. In some embodiments, biomass other than rejects may be conveyed to furnace 222 as fuel. For example, in some embodiments, unscreened biomass from receiving 114 may be conveyed to furnace 222 as fuel. After application of method 100, surge bins may be used to hold biomass to be used as feedstock for torrefaction and/or to hold biomass to be used as solid fuel.

FIG. 2 illustrates a block diagram of selected components of an example integrated biomass torrefaction and biofuel production system 200, in accordance with certain embodiments of the present disclosure. As shown in FIG. 2, torrefaction system 200 may include airlocks 206, 212, 214, 216, and 218, separator 208, screener 209, intermediate storages 210, 219, leaching system 202, Dewatering equipment 203, filtering equipment 204, water purification system 205, biomass dryer 207, metering bin 211, preheater 213, heat exchanger 224, heat transfer systems 226, biomass/torgas burner 222, torrefaction reactor 215, stabilizer/conditioner 217, densifier 220, fan 227 (e.g., and induced draft fan), and algaculture production system 225. In addition, although not explicitly depicted in FIG. 2 for the purpose of clarity, integrated biomass and biofuel production system 200 may include any number and any suitable types of conveyors configured to convey biomass, fluids, and/or other material between or within various components of integrated biomass and biofuel production system 200. For example, to convey solid material (e.g., biomass) a conveyor may include a chain conveyor, belt conveyor, drag conveyor, bucket elevator, vibratory conveyor, walking-floor conveyor, piston conveyor, screw conveyor, pneumatic transfer conveyor, and/or any other suitable conveyance system for transporting biomass and/or other material. To convey fluid material (e.g., liquids or gasses), a conveyor may include one or more pipes or other fluid conduits, one or more pumps, fans or other devices for displacing fluids, valves, and/or other suitable components for conveying such fluid.

A suitable conveyor may convey biomass to leaching system 202. Leaching system 202 may include any system, vessel, device, or apparatus configured to leach water soluble elements and other combustion unfriendly chemical components (e.g., volatile matter, chlorine, potassium, sodium, magnesium, phosphorus, calcium, and silica) from biomass and/or wash surface contaminants (e.g., dirt) from biomass, thus producing biomass with a lower concentration of such combustion unfriendly chemical components and a high-nutrient water effluent. As described elsewhere in this disclosure, the high-nutrient water may be used as an effluent for algae growth and production by algaculture production system 225. Leaching system 202 may also cause certain combustion unfriendly chemical components (e.g., chlorine) remaining in biomass after the leaching process to convert to a different state of matter (e.g., from solid to liquid), such that certain combustion unfriendly chemical components may be converted into a gaseous phase during the torrefaction process described in greater detail elsewhere in this disclosure.

Leaching system 202 may employ either a continuous or a batch process in which a leaching solution comprised of water and/or other chemicals may be used to facilitate leaching of combustion unfriendly chemical components from the biomass. In some embodiments, water which has been filtered by filtering system 204 and/or purified by water purification system 205 may be used. In these and other embodiments, water used in leaching system 202 may include and/or be combined with certain chemicals to aid in the leaching of the combustion unfriendly chemical components, including without limitation surfactants, chelates, and/or pH lowering acids (e.g., sulfuric acid, hydrochloric acid, muriatic acid, etc.). In these and other embodiments, leaching system 202 may be configured such that its materials of construction are able to withstand potentially low pH levels that may be used in the leaching solution. In these and other embodiments, leaching system 202 may be configured such that the biomass remains in the presence of a leaching solution for a specific period of time to allow the leaching process to occur. Leaching system 202 may be constructed in a way to allow a combination of vacuums and pressures to be used to facilitate the removal of combustion unfriendly chemical components from the biomass. Furthermore, leaching system 202 may utilize heat to aid in the dispersion of combustion unfriendly chemical components from the biomass. Additional steps may be added before, during, or after the leaching process to enhance the leaching of the combustion unfriendly chemical components from the biomass such as, for example, technologies that use electric or mechanical forces to break open cell walls in the biomass to accelerate the leaching process. Leaching system 202 may be implemented as single vessel, or a plurality of vessels in parallel or serial configurations. In one embodiment, the one or more vessels comprising leaching system 202 may be part of an in ground system which permits biomass to soak for longer periods of time in the leaching solution before it is removed.

After the leaching system 202 process has been completed, biomass may be conveyed to a mechanical de-watering unit 203 may be used to extract a portion of the high-nutrient water effluent from the biomass prior to drying. Mechanical de-watering unit 203 may include any system, device, or apparatus configured to remove excess water and/or effluent remaining in biomass after leaching performed by leaching system 202. Such de-watering may reduce the water content of the biomass so as to reduce the amount of time or energy required by biomass dryer 207 to dry the biomass prior to torrefaction. In some embodiments, mechanical de-watering unit 203 may comprise a mechanical screw press. As shown in FIG. 2, de-watering unit 203 may receive biomass from leaching system 202 as an input, and may output biomass with a reduced moisture content and also output an effluent comprising a high-nutrient water comprising dissolved and non-dissolved solids. The biomass output by de-watering unit 203 may be conveyed or otherwise delivered to biomass dryer 207. In some embodiments, the dewatering operation may be eliminated and the wet biomass may be conveyed directly from leaching system 202 to biomass dryer 207.

Non-dissolved solids filter 204 may include any system, device, or apparatus configured to filter non-dissolved solids (e.g., dirt, silica, etc.) from effluent water received from leaching system 202 and/or mechanical de-watering unit 203, thus producing an effluent substantially free of non-dissolved solids. For example, non-dissolved solids filter 204 may comprise a sieve and/or other similar device configured to filter solid matter from a liquid. Non-dissolved solids filtered by non-dissolved solids filter 204 may be disposed of in any suitable manner (e.g., delivered to landfill, resold as a component for bedding soil, etc.).

Water purification system 205 may include any system, device, or apparatus configured to filter, using reverse osmosis and/or any other suitable method, nutrients and other chemical components from filtered effluent output by non-dissolved solids filter 204, thus producing a nutrient-rich water and a “clean” water substantially free of impurities and contaminants. Nutrient-rich water output by water purification system 205 may have a higher nutrient concentration than the effluent water input to water purification system 205. As shown in FIG. 2, clean water output by water purification system 205 may be conveyed to leaching system 202 for reuse. On the other hand, high-nutrient water output by water purification system 205 may be conveyed to algaculture production system 225, where it may used as a nutrient feedstock for algae production, as described in greater detail below.

Although system 200 depicts two phases of effluent filtering (non-dissolved solids filter 204 and water purification system 205), it is understood that system 200 may include more or fewer phases of effluent filtering and/or system 200 may use filtering techniques other than those specifically described above.

After mechanical de-watering unit 203 operation has been completed the dewatered biomass may be temporarily stored in an intermediate storage bin (not explicitly shown in FIG. 2) before it is dried in biomass dryer 207. Biomass dryer 207 may include any suitable system, device, or apparatus for drying biomass (e.g., biomass from leaching system 202). Biomass dryer 207 may include an oven, kiln, and/or other suitable heating apparatus. In some embodiments, biomass dryer 207 may include a direct-fired triple-pass rotary biomass dryer, such as that commercially available from Baker-Rullman Manufacturing Inc., for example. As shown in FIG. 2, and described in greater detail below, biomass dryer 207 may receive heat from biomass and/or torgas burner 222 via any suitable thermal conduit. Such heat may be generated by biomass and/or torgas burner 222 and transferred via a thermal conduit by air (e.g., by means of a fan or blower), thermally-conductive oil, or other fluid present in the conduit, in order to transfer heat to the biomass via conductive, convective and/or radiant heat transfer. Using such heat, dryer 215 may reduce the moisture content of biomass conveyed to biomass dryer 207 (e.g., to a desired moisture content of approximately 5% to approximately 10%). During the drying process, biomass may give off water vapor, light volatile organic compounds (VOCs), biomass particulates, and/or other matter. Accordingly, biomass and air within biomass dryer 207 may be separated by separator 208.

Separator 208 may include any system, device, or apparatus configured to separate gasses and small particulate matter from larger, solid biomass particles. In some embodiments, separator 208 may include a cyclone configured to separate biomass from air (hot flue gas) using cyclonic separation. In these and other embodiments, and as shown in FIG. 2, all or a portion of such exhaust may also be conveyed (e.g., via fan 227 and/or suitable conduits) as a source of carbon dioxide and/or other chemical elements to algaculture production system 225. In addition, also as shown in FIG. 2, a portion of the separated gasses and particulates may be re-directed (e.g., via fan 227 and/or suitable conduits) to biomass and/or torgas burner 222, as described in greater detail below, in order to prevent environmental pollution that may be caused by excessive discharge of VOCs, and/or particulate matter. In these and other embodiments, a portion of the separated gasses and particulates may be vented for discharge (e.g., via fan 227 and/or suitable conduits) into the environment as emissions. In these and other embodiments, a portion of the exhaust separated by separator 208 may be circulated to stabilizer/conditioner 217 (e.g., via fan 227 and/or suitable conduits), in order to provide heat to internal space of stabilizer/conditioner 217 in order to maintain a desired temperature of torrefied biomass in stabilizer/conditioner 217.

The dried and separated biomass may be further screened by screener 209 prior to being conveyed to intermediate storage 210 in order to remove any fines generated by leaching system 202, dewatering equipment 203, and/or biomass dryer 207. Screener 209 may include any system, device, or apparatus configured to separate received biomass by size, weight, shape, and/or other characteristic in order to segregate biomass particles into those deemed unsuitable for torrefaction and conversion into RCRF (“fines”) and those suitable for torrefaction. Screener 209 may include a screening system, masks, and/or other similar device. A suitable conveyor may convey fines from screener 209 to biomass and/or torgas burner 222, where such fines may be used as solid fuel for biomass and/or torgas burner 222, as described in greater detail below. Another suitable conveyor may convey remaining biomass to intermediate storage 210.

Intermediate storage 210 may include any suitable container for temporarily storing biomass prior to conveyance to metering bin 211. In some embodiments, intermediate storage 210 may comprise a surge bin. A suitable conveyor may convey biomass from intermediate storage 210 to metering bin 211.

Metering bin 211 may include any system, device, or apparatus configured to measure and/or convey (e.g., by weight, volume, or other suitable characteristic) a desired amount of biomass to preheater 213. A suitable conveyor may convey a desired amount of biomass metered by metering bin 211 to airlock 212.

Airlock 212 may comprise any system, device, or apparatus that may permit the passage of biomass between metering bin 211 and preheater 213 while minimizing exchange of gas between the space internal to preheater 213 and the space external to preheater 213, in order to ensure the space internal to preheater 213 remains a substantially oxygen-deprived environment (e.g., an oxygen content at or below approximately 2% in some embodiments). For example, airlock 212 may include an airlock, feeder, load lock, or other suitable device. In certain embodiments, airlock 212 may comprise a rotary airlock, thus permitting substantially continuous conveyance of biomass from metering bin 211 to preheater 213.

Preheater 213 may include any oven, kiln, or other suitable heating apparatus suitable for heating biomass to a desired temperature (e.g., approximately 230° C. to approximately 300° C.) over a desired period of time (e.g., approximately 5 minutes to approximately 30 minutes) in an oxygen deprived-environment (e.g., an oxygen content at or below approximately 2% in some embodiments) for preheating the biomass to a desired temperature for torrefaction. Preheater 213 may include a suitable conveyor for conveying biomass (e.g., including a substantially continuous stream of biomass) from an input of preheater 213 (e.g., proximate to airlock 212) to an output of preheater 213 (e.g., proximate to airlock 214). As shown in FIG. 2, and described in greater detail below, preheater 213 may receive heat from heat transfer system 226. Heat received via heat transfer system 226 may be used to heat biomass in preheater 213 via conductive, convective, and/or radiant heat transfer. In some embodiments, preheater 213 may receive heat from heat transfer system 226 such that such heat may be used to warm up preheater 213 on system startup and/or may adjust heat as required during preheating to maintain the target exit temperature. Preheater 213 may have a number of heating zones whereby heat transfer system 226 provides different temperatures within different zones of preheater 213 to provide greater control of the preheating process.

Hot flue gas produced by biomass and/or torgas burner 222 from burning of biomass and/or torgas may be used to heat a thermally-conductive media in close proximity to biomass and/or torgas burner 222 via heat exchanger 224. Heat transfer system 226 may then deliver this heated thermally-conductive media to preheater 213, torrefaction reactor 215, and/or other components that may benefit from heated thermally-conductive media. Accordingly, heat generated by biomass and/or torgas burner 222 may be transferred via heat exchanger 224 into a thermally-conductive oil, or other fluid present in the conduit, from which it may be transferred to preheater 213 and/or torrefaction reactor 215 via heat transfer system 226. In some embodiments, heat transfer system 226 may contain valves, pumps, expansion tanks, piping, and control systems to convey the thermally conductive oil to preheater 213, torrefaction reactor 215, stabilizer/conditioner 217, and/or densifier 220, and back to heat exchanger 224 and/or heat transfer system 226. In certain embodiments, heat transfer system 226 may use electric block heaters directly attached to preheater 213 and/or torrefaction reactor 215 and the heat from biomass and/or torgas burner 222 may be used to create electricity for the block heaters as opposed to provide heat directly to preheater 218 and/or torrefaction reactor 215. In some embodiments, airlock 214 may not be used.

Airlock 214 may comprise any system, device or apparatus that may permit the passage of biomass between preheater 213 and torrefaction reactor 215 while minimizing exchange of gas between preheater 213 and torrefaction reactor 215, in order to provide thermal isolation between preheater 213 and torrefaction reactor 215. For example, airlock 214 may include an airlock, feeder, load lock, or other suitable device. In certain embodiments, airlock 214 may comprise a rotary airlock, thus permitting substantially continuous conveyance of biomass from preheater 213 to torrefaction reactor 215.

Torrefaction reactor 215 may include any oven, kiln, or other suitable apparatus suitable for maintaining the temperature of the heated biomass at a desired temperature (e.g., approximately 230° C. to approximately 300° C.) and for a desired period of time (e.g., approximately 15 minutes to approximately 40 minutes) in a substantially oxygen-deprived environment (e.g., an oxygen content at or below approximately 2% in some embodiments) for torrefying biomass. Torrefaction reactor 215 may include a suitable conveyor for conveying biomass (e.g., including a substantially continuous stream of biomass) from an input of torrefaction reactor 215 (e.g., proximate to airlock 214) to an output of torrefaction reactor 215 (e.g., proximate to airlock 216). As shown in FIG. 2, and described in greater detail below, torrefaction reactor 215 may receive heat from via heat transfer system 226. Heat received via heat transfer system 226 may be used to heat biomass in torrefaction reactor 215 via conductive, convective, and/or radiant heat transfer. In some embodiments, torrefaction reactor 215 may receive heat from a heat transfer system 226 such that it may be used to warm up torrefaction reactor 215 on system startup and/or may maintain target heating temperature as desired during torrefaction. Torrefaction reactor 215 may have a number of zones whereby heat transfer system 226 provides different temperatures into different heating zones of torrefaction reactor 215 to provide greater control of the torrefaction process.

Airlock 216 may comprise any system, device, or apparatus that may permit the passage of biomass between torrefaction reactor 215 and stabilizer/conditioner 217 while minimizing exchange of gas between the space internal to torrefaction reactor 215 and stabilizer/conditioner 217, in order to prevent air in the space internal to torrefaction reactor 215 from mixing significantly with air in the space internal to stabilizer/conditioner 217. For example, airlock 216 may include an airlock, feeder, load lock, or other suitable device. In certain embodiments, airlock 216 may comprise a rotary airlock, thus permitting substantially continuous conveyance of biomass from torrefaction reactor 215 to stabilizer/conditioner 217.

As depicted in FIG. 2, the combination of preheater 213 and torrefaction reactor 215 may provide for a multiple-phase torrefaction process. For example, the combination of preheater 213 and torrefaction reactor 215 may provide for a two-phase torrefaction process. In the first phase, preheater 213 may heat biomass from a first temperature (e.g., the approximate temperature of biomass when exiting biomass, which may be between approximately 50° C. to approximately 60° C. in some embodiments) to a second temperature (e.g., approximately 230° C. to approximately 300° C.), wherein the first temperature is the temperature of biomass at an input of preheater 213 and the second temperature is an approximate desired torrefaction temperature, In the second phase, torrefaction reactor 215 may maintain biomass at or about (e.g., within approximately 20° C.) of the second temperature (e.g., approximately 230° to approximately 300° C.).

As another example, the combination of preheater 213 and torrefaction reactor 215 may provide for a three-phase torrefaction process. In such a process, preheater 213 may be divided into two portions, which may be thermally isolated from one another by an airlock or other appropriate device. In the first phase, the first portion of preheater 213 may heat biomass from a first temperature (e.g., approximately 50° to approximately 60° C.) to a second temperature (e.g., approximately 200° C.) over a particular period (e.g., approximately 5 minutes to approximately 15 minutes), wherein the first temperature is the temperature of biomass at an input of preheater 213 and the second temperature is may be a temperature at which moisture from biomass may be evaporated, but below a temperature at which the biomass may release significant amounts of volatile organic compounds.

In the second phase, the second portion of preheater 213 may heat biomass from the second temperature (e.g., approximately 200° C.) to a third temperature (e.g., approximately 230° to approximately 300° C.) over a particular period of time (e.g., approximately 15 to approximately 30 minutes), wherein the third temperature is an approximate desired torrefaction temperature. In the third phase, torrefaction reactor 215 may maintain biomass at or about (e.g., within approximately 20° C.) of the third temperature (e.g., approximately 230° to approximately 300° C.).

In some embodiments of torrefaction system 200, preheater 213 may not be present (e.g., such that torrefaction reactor 215 is coupled to airlock 212), thus providing for a single-stage torrefaction process. In such embodiments, torrefaction reactor 215 may heat biomass from a temperature of approximately 50 to approximately 60° F. at its input to approximately 230° C. to approximately 300° C. at its output.

In certain applications, a multi-stage torrefaction process may be preferred because it may provide for desired decomposition of certain components of the biomass while reducing or eliminating decomposition of other components as compared with a single-stage process. For example, it may be desirable to prevent decomposition of lignin in the biomass, as lignin may provide desirable properties in torrefied biomass, including acting as a binding agent for densifying (e.g., pelleting and/or briquetting) torrefied biomass. The two-stage torrefaction process herein may allow a themo-chemical reaction of hemicellulose present in biomass to occur at a temperature below that at which lignin present in the biomass is reactive, while the single-stage process as described herein may lead to substantial decomposition of lignin. Thus, the two-stage process provides for a first region in which biomass may be heated to a desired temperature, and then a second region in which the biomass may be held at the desired temperature for long periods of time to provide for desired decomposition of certain components (e.g., hemicellulose) while possibly reducing the likelihood of overtorrefying (e.g., decomposing lignin or other components that may be desirable to retain) or the likelihood of the biomass reaching a temperature at which it may undergo an undesirable exothermic reaction.

A three-stage torrefaction process such as the one disclosed above may also provide additional advantages. The first portion of preheater 213 may allow heating of biomass to a temperature above which evaporation of moisture content will occur, but below that at which the biomass will generate significant amounts of volatile organic compounds. The second portion may allow heating at a higher temperature above which significant generation of volatile organic compounds occurs but below that at which significant torrefaction of the biomass occurs. Accordingly, because significant generation of volatile organic compounds may occur in a portion of preheater 213, rather than throughout preheater 213, handling of volatile organic compounds may be simplified. Also, because torrefection may require careful control of various temperatures in the torrefection process, a two-part heating process in preheater 213 may allow for simplification of the controls for heating biomass.

In each of the single-phase and multiple-phase torrefaction processes described above, heating of biomass by torrefaction in preheater 213 and torrefaction reactor 215 may cause torrefaction of biomass, in which an approximate 10% to 20% reduction in energy content of the biomass and an approximate 30% to 40% reduction in mass of the biomass may occur. Because the loss of mass is greater than the loss of energy, the remaining energy is effectively concentrated in a smaller amount of mass resulting in a higher calorific value. The reduction in energy content may be caused primarily by the partial decomposition of the biomass, which may give off volatile organic compounds, or “torgas”. As shown in FIG. 2, such torgas may be exhausted from torrefaction reactor 215 via a suitable conduit, such that the torgas may be used as fuel for biomass and/or torgas burner 222. In addition, in embodiments in which it is present, preheater 213 may also exhaust torgas via suitable conduits, such that torgas exhausted by preheater 213 may be used as a fuel for biomass and/or torgas burner 222. Such use of torgas as a fuel for biomass and/or torgas burner 222 may render system 200 a largely autothermal torrefaction system.

In addition to being delivered from preheater 213 and/or torrefaction reactor 215 to biomass and/or torgas burner 222 as a fuel, torgas may also, in some embodiments, be refined and/or segregated into its component gasses, which may then be stored, sold and/or used for fuel for applications other than for use in system 200.

As described above, a reduction in mass of biomass during torrefaction may be caused by a reduction in the moisture content in the biomass and the volatilization of organic compounds. For example, torrefaction in torrefaction reactor 215 may reduce the moisture content of the biomass from less than approximately 10% to less than approximately 2%. Such moisture may be given up in the form of vapor, which may be exhausted to the environment (e.g., via a stack or other appropriate exhaust).

In addition, the torrefaction process performed by preheater 213 and torrefaction reactor 215 may further reduce the content of combustion unfriendly chemical components. For example, torrefaction may devolatilize_water-dissolved chlorine present in the biomass, further reducing the chlorine content of the biomass.

Leaching system 202 in concert with preheater 213 and/or torrefaction reactor 215 may significantly reduce the content of combustion unfriendly chemical components (e.g., chlorine, potassium, sodium, magnesium, phosphorus, calcium, and silica) in biomass and/or reduce the content of ash, rendering RCRF produced by system 200 more suitable for use in coal-burning power plants. As described above, leaching system 202 may effectively extract undesirable water-soluble combustion unfriendly chemical components from biomass and/or cause combustion unfriendly chemical components (e.g., chlorine) to convert from a solid phase to a liquid phase. Heat from preheater 213 and/or torrefaction reactor 215 may devolatize such liquid phase combustion unfriendly chemical components into a gas phase, thus releasing such combustion unfriendly chemical components from the biomass. In the gas phase, such combustion unfriendly chemical components may be conveyed to biomass and/or torgas burner 222 where they may be incinerated, thus potentially reducing not only the presence of undesirable combustion unfriendly chemical components in biomass and RCRF, but also preventing emission of such extracted combustion unfriendly chemical components to the environment once extracted from the biomass during the leaching and torrefaction process.

As set forth above, biomass dryer 207, preheater 213, and torrefaction reactor 215 may be supplied with heat from biomass and/or torgas burner 222. Biomass and/or torgas burner 222 may comprise any suitable system configured to combust a plurality of different fuels to generate heat. For example, in some embodiments, biomass and/or torgas burner 222 may be configured to combust biomass produced at one or more steps of method 100 (e.g., out-of-spec material, oversized chips, and/or particulates from receiving 114, screening 116, milling 118, and milling 120, and/or torrefied RCRF and/or out-of-spec densified pellets or briquettes from densifier 220) and torgas produced by preheater 213 and/or torrefaction reactor 215, thus providing a predominantly autothermal system that requires relatively little or no fuel other than that obtained from harvested biomass. In certain such embodiments, biomass and/or torgas burner 222 may be further configured to burn natural gas or another “traditional” fuel, and may use such traditional fuel for initial startup (e.g., to ramp up to a steady-state operational state) or in instances in which insufficient biomass products are available for burning at desired operational states, and such traditional fuel may be reduced once steady-state operation has been achieved and/or sufficient biomass-based fuel is available. In addition, in these and other embodiments, biomass and/or torgas burner 222 may be configured to receive and incinerate VOCs and/or particulate matter separated by separator 208, thus potentially reducing or eliminating any need to emit such VOCs and/or particulate matter into the environment. In the embodiments set forth above and other embodiments, biomass and/or torgas burner 222 may comprise any commercially available biomass burner, solid fuel burner, or other multi-fuel burner.

Thus, biomass and/or torgas burner 222 may receive its fuel from three sources (e.g., biomass, torgas, and some fraction of traditional fuel for start up). As used in system 200, biomass and/or torgas burner 222 may serve two functions: a) to produce heat required for biomass dryer 207, preheater 213, and torrefaction reactor 215 via heat exchanger 224 and/or heat transfer system 226, and b) to incinerate a large fraction of VOCs and particulate matter from preheater 213 and torrefaction reactor 215 and/or at least a portion of VOCs separated by separator 206. The heat from biomass and/or torgas burner 222 is shared among biomass dryer 207 which requires both a mass of air and high temperature and preheater 213, torrefaction reactor 215, stabilizer/conditioner 217, and densifier 220. Biomass and/or torgas burner 222 may maintain a high enough temperature to incinerate VOCs, while providing the necessary heat for components of system 200. Accordingly, biomass dryer 207, torrefaction reactor 215, stabilizer/conditioner 217, and (when present) preheater 213, may form an integrated torrefaction system. Thus, while each component of the integrated system is a discrete component, the mass and energy balance, fuel supply, heat transfer, emissions control, and operation are shared in a way to optimize overall performance of the integrated system.

Airlock 216 and/or suitable conveyor may convey torrefied biomass from torrefaction reactor 215 to stabilizer/conditioner 217. Stabilizer/conditioner 217 may be any system, device, or apparatus configured to substantially simultaneously stabilize torrefied biomass to reduce or eliminate the possibility of spontaneous combustion while preparing or conditioning the torrefied biomass for densification. Stabilization of torrefied biomass may include cooling the torrefied biomass, as the temperature at which the biomass is torrefied in torrefaction reactor 215 may be at or above the flash point of the biomass, where exposure of the biomass to ambient air at the completion of torrefaction without cooling may cause combustion due to the presence of sufficient oxygen in the air. Conditioning of torrefied biomass may include modifying one or more characteristics of the torrefied biomass to improve or maintain suitability of the biomass for densification. For example, conditioning may include increasing moisture content in the torrefied biomass (e.g., to between approximately 5% to approximately 10%) which may act as a lubricant and/or a heat transfer agent during densification. Such increase in moisture content may also facilitate a cessation of thermochemical reactions that take place in the biomass during torrefaction. Conditioning may also include maintaining the biomass above a particular temperature in order to achieve properties desirable for densification. For example, maintaining biomass above a certain temperature (e.g., above 80° C.) may increase the throughput, decrease the energy consumption, and/or decrease frictional wear of the densification equipment. Accordingly, substantially simultaneous stabilization and conditioning may not only stabilize torrefied biomass, but may also reduce or eliminate a need for a separate conditioning step prior to densification.

To substantially simultaneously stabilize and condition torrefied biomass, stabilizer/conditioner 217 may apply water and/or other liquid to torrefied biomass while the torrefied biomass is at or near its temperature of torrefaction (e.g., approximately 230° C. to approximately 300° C.). Such spraying of liquid upon biomass may cause cooling of biomass and generation of steam as the fluid evaporates due to heat transfer from the hot torrefied biomass. This generation of steam may further prevent combustion of the torrefied biomass, as steam expansion may force any oxygen present in stabilizer/conditioner 230 away from the biomass. In addition, application of water to cool biomass may also condition biomass for densification. Stabilizer/conditioner 217 may include moisture analysis equipment configured to measure the moisture content of the torrefied, stabilized, and conditioned biomass and/or adjusts the amount of water being applied such that a target moisture content is maintained. Similarly, temperature in stabilizer/conditioner 217 may be controlled with thermocouples that adjust the amount of heat or cooling that is applied to the biomass in order to maintain a target temperature upon exit.

The stabilized and conditioned torrefied biomass may exit stabilizer/conditioner 217 through an airlock 218. Airlock 218 may comprise any system, device, or apparatus that may permit the passage of biomass between stabilizer/conditioner 217 and intermediate storage 219 while minimizing exchange of gas between the space internal to stabilizer/conditioner 217 and the space external to stabilizer/conditioner 217, in order to ensure the space internal to stabilizer/conditioner 217 remains a substantially oxygen-deprived environment (e.g., an oxygen content at or below approximately 2% in some embodiments). For example, airlock 218 may include an airlock, feeder, load lock, or other suitable device. In certain embodiments, airlock 218 may comprise a rotary airlock, thus permitting substantially continuous conveyance of biomass from stabilizer/conditioner 217 to intermediate storage 219.

Intermediate storage 219 may include any suitable container for temporarily storing biomass prior to conveyance to densifier 220. In some embodiments, intermediate storage 210 may comprise a surge bin. A suitable conveyor may convey biomass from intermediate storage 219 to densifier 220, where it may be densified into pellets, briquettes or other forms.

As described above, improvement of biomass through leaching and mechanical processes prior to RCRF production processes reduces the combustion unfriendly chemical components to acceptable levels for safe combustion. This biomass improvement process, however, produces and effluent (e.g., leachate) which oftentimes must be disposed of or repurposed in order to achieve environmental compliance and economic viability. Algaculture production system 225 may serve as a mechanism in which to repurpose such effluent.

Algaculture production system 225 may comprise any system, device, or apparatus configured to receive water, nutrients, carbon dioxide, heat, and/or other input sources in order to grow or cultivate algae and to harvest such algae to obtain algae oils and/or other algae co-products (e.g., cellulose which may be converted to methane or other fuel). As shown in FIG. 2, nutrient-rich water output by leaching system 202 may be conveyed to algaculture production system 225. In some embodiments, other nutrient sources and/or water sources may be input to algaculture production system 225 in addition to or in lieu of nutrient-rich water received from leaching system 202. As also depicted in FIG. 2, emissions from fan 227 may be conveyed to algaculture production system 225. Such emissions may include carbon dioxide, carbon monoxide, and/or other hazardous air pollutants that may be metabolized by algae within algaculture production system 225. In addition, as shown in FIG. 2, algaculture production system 225 may receive heat from biomass and/or torgas burner 222 via any suitable thermal conduit. Such heat may be present in the emissions and/or generated by biomass and/or torgas burner 222 and transferred via a thermal conduit by air (e.g., by means of a fan or blower), thermally-conductive oil, or other fluid present in the conduit, in order to transfer heat to algaculture production system 225 via conductive, convective and/or radiant heat transfer. Such heat may be used (e.g., in connection with a temperature control system) to establish an optimum temperature for metabolic processes of algae within algaculture production system 225.

In some embodiments, algaculture production system 225 may include one or more holding tanks to receive water, nutrient-rich water, and/or other liquids to be used by algaculture production system 225. In these and other embodiments, algaculture production system 225 may also include a suitable mixing apparatus for mixing such received water (including nutrient-rich water) with received emissions in order to provide a desired mix of water, nutrients, and gasses (e.g., carbon dioxide) for the metabolic processes of algae within algaculture production system 225.

In operation, algaculture production system 225 may grow algae, as algae metabolize nutrients and emissions gasses (e.g., carbon dioxide). After sufficient algae growth, such algae may be harvested to extract algae oils and/or other co-products that may be used as fuels and/or for other commercial purposes. In addition, such metabolizing of nutrients and emission gasses may produce “clean” water substantially free of impurities and contaminants. In some embodiments, such clean water may be conveyed to leaching system 202 for use in the leaching process described elsewhere in this disclosure. Furthermore, the metabolizing of emissions gasses may lead to reduced emissions from the torrefaction process, thus reducing or eliminating pollution and/or reducing exposure to environmental statutes and regulations.

Thus, system 200 provides an integrated fuel production system that may be substantially environmentally neutral, as system 200 may use sustainable sources for RCRF production, reduce the content of combustion unfriendly chemical components in the RCRF through leaching and torrefaction, use byproducts of RCRF production and leaching as a nutrient feedstock for algae product production, use byproducts of RCRF production as a fuel source to provide heat to the RCRF production and algae production processes, allows for repurposing and reuse of water through the RCRF production and algae production processes, and metabolizes hazardous air pollutants generated by the RCRF production process in order to produce algae.

What is claimed is:

1. A system, comprising:
a leaching system configured to receive biomass and leach the biomass such that water soluable combustion unfriendly chemical components present in the biomass are leached into an effluent; and
a torrefaction reactor configured to receive the leached biomass and heat the biomass to generate torrefied biomass.

2. A system according to claim 1, further comprising a preheater interfaced between the leaching system and the torrefaction reactor and configured to heat biomass from a first temperature to an approximate desired torrefaction temperature.

3. A system according to claim 1, further comprising a mechanical de-watering system interfaced between the leaching system and the torrefaction reactor and configured to remove water introduced to the biomass by the leaching system.

4. A system according to claim 3, wherein the mechanical de-watering system comprising a mechanical screw press.

5. A system according to claim 1, further comprising a non-dissolved solids filter configured to filter non-dissolved solids extracted from the biomass and present in the effluent.

6. A system according to claim 1, further comprising a water purification system configured to filter the effluent to produce a purified water substantially free of impurities and contaminants.

7. A system according to claim 6, the leaching system further configured to receive the purified water from the water purification system.

8. A system according to claim 6, the water purification system comprising a reverse osmosis filter.

9. A system according to claim 6, the water purification system further configured to produce a high-nutrient water including nutrients from leached from the biomass by the leaching system.

10. A system according to claim 9, further comprising an algaculture production system configured to cultivate algae using the high-nutrient water.

11. A system according to claim 1, the leaching system comprising a leaching solution comprises of water.

12. A system according to claim 12, the leaching solution further comprising at least one of a surfactant, chelate, and pH-lowering chemical.

13. A system comprising:
a leaching system configured to receive biomass and rinse the biomass such that combustion unfriendly chemical components present in the biomass are leached into an effluent;
a torrefaction reactor configured to receive the leached biomass and heat the biomass to generate torrefied biomass; and
an algaculture production system configured to:
receive at least a portion of the effluent from the leaching system; and
cultivate algae in a liquid comprising the portion of the effluent received from the leaching system.

14. A system according to claim 13, further comprising a furnace configured to generate and convey via one or more conduits heat to the torrefaction reactor and the algaculture production system.

15. The system of claim 14, the furnace further configured to combust one or more volatile organic compounds generated by the torrefaction reactor to generate at least a portion of the heat.

16. A system according to claim 13, the algaculture production system further configured to:
receive emissions gasses generated by torrefaction of the biomass; and
cultivate the algae using carbon dioxide present in the emissions gasses.

17. A system according to claim 13:
the algaculture production system further configured to metabolize liquid received by the algaculture production system to produce a purified water substantially free of impurities and contaminants; and
the leaching system further configured to receive the purified water and mix the clean water with at least an acidic chemical to produce the acidic solution.
